(19) United States
(12) Patent Application Publication
(10) Pub. No.: US 2019/0029922 A1
(43) Pub. Date: Jan. 31, 2019

(54) MEASURING DEVICE FOR A CAPSULE FILLER MACHINE FOR PHARMACEUTICAL CAPSULES

(71) Applicant: MG2 - S.R.L., Pianoro (BO) (IT)

(72) Inventors: Antonio TAGLIAVINI, BOLOGNA (IT); Ernesto GAMBERINI, RASTIGNANO (BO) (IT)

(21) Appl. No.: 16/046,309

(22) Filed: Jul. 26, 2018

(30) Foreign Application Priority Data
Jul. 27, 2017 (IT) 102017000086434

(51) Int. Cl. A61J 3/07; B65B 1/04

(52) U.S. Cl. CPC A61J 3/074; B65B 7/28; A61J 2200/74; B65B 1/04

(57) ABSTRACT

A measuring device for a capsule filler machine for pharmaceutical capsules comprising at least one block, provided with a plurality of seats, suitable to house a plurality of bottoms of capsules to be filled is provided. The block is provided with capacitive electronic devices, which are suited to detect parameters concerning the tare of each bottom, parameters concerning the quantities and the types of the products inserted into each bottom, and parameters concerning the filling/emptying of the seats, so as to control, in particular, the filling steps carried out to fill the capsule bottoms with the products.

### CROSS-REFERENCE TO RELATED APPLICATIONS

This application claims priority from Italian Patent Application No. 102017000086434 filed on Jul. 27, 2017, the disclosure of which is incorporated by reference.

### TECHNICAL FIELD

The present invention relates to a measuring device suitable to be combined with a capsule filler machine of pharmaceutical capsules.

The measuring device of the present invention can be mounted on the capsule filler machine or, as we will see, may be separate from it and used, for example, only to carry out weight measurements on full or empty capsules. In actual fact, even if in the present description, for the sake of clarity, the term “weight” is used, the system described performs more specifically a mass measurement, independently of the acceleration of gravity and other accelerations present, and this represents a considerable advantage over the traditional scales, usually gravimetric, gravity-based and intrinsically sensitive to other accelerations that may be present.

As will be better seen below, the measuring device of the present invention operates by using a capacitive electronic system based on the dielectric properties of the materials that constitute the casing and its contents in order to determine its mass, as has been described and illustrated in document WO-A2-2006/035285 filed in the name of the same applicant.

### BACKGROUND OF THE INVENTION

As is known, the measurement of the mass of the contents of a pharmaceutical capsule with capacitive methods, as described in the document WO-A2-2006/035285, brings numerous advantages compared to methods based on traditional mechanical scales using strain-gauge or piezoelectric transducers (hereinafter referred to as “traditional systems”).

The first advantage of the capacitive solution adopted in the present invention consists in the speed of the system, purely electronic and without moving parts, a system which allows, in fact, a measurement carried out on 100% of the production even on very high speed machines.

With traditional methods, measurement of 100% of production requires a considerable battery of scales operating in parallel at the output of the machine.

Without considering the cost and the delicacy of this solution, it is, however, a “post process” measurement of gross weight.

To derive from this measure the net weight of the product contained in each capsule is only possible if we assume as weight of the tare (casing) either a nominal value, or an average weight to be determined off-line, and in any case not the actual weight that the capsule itself has before being filled.

It is evident how this leads to considerable uncertainty, especially in the case of so-called “low doses”, in which the ratio between the mass of the drug and the casing tends to progressively fall.

Furthermore, the integration in the machine of a traditional measuring system is very problematic due to the mechanical stresses existing during the various operating phases, without considering other factors such as size and cost.

These disadvantages are particularly significant both in the case of machines with a discontinuous movement and in machines with intermittent motion which will be discussed below.

Conversely, an important advantage of the capacitive measuring system referred to in document WO-A2-2006/035285 consists in the fact that it can be easily used on board the machine by integrating it with the dosage components mounted in the moving parts of the machine itself in order to follow each single capsule during all the phases of its journey.

Moreover, a capacitive measuring system is much less dependent on mechanical stress than traditional systems and this is particularly important in an intermittent motion machine.

A measuring system on the machine such as that described above can perform measurements on the same capsule during the various operating phases with the same transducer, and this permits various possibilities.

As has been said, the first is to make a measurement of the tare/gross type in a very simple manner, first measuring the mass of the base only, then the mass of the same base once filled. This way it is possible to determine more precisely the mass of the net content compared to the traditional “post process” methods, in which only one gross measurement is made of the closed capsule, deriving the net by subtracting a nominal value, or at most obtained using an average weight, for the complete casing.

Furthermore, a further advantage of the application on board the machine lies in the fact that the casing (tare) is constituted in this case only by the bottom, and not by the closed casing, complete with cap, since in the dosing phases it is obviously only the bottom which is present.

The errors introduced in the measurement of the tare (the bottom alone) thus have less influence (roughly half) on the accuracy of the measurement.

This is of particular importance in the aforementioned case of “low dosages”, i.e. smaller quantities of drug inserted in said casing.

Another important advantage is that the measurement in the various operating steps always takes place with the bottom in the same position inside the same transducer.

The advantages are particularly evident in machines in which, in successive stations, various products, even heterogeneous (such as, for example, powders, granules, micro-tablets, etc.) are deposited in the same bottom.

With the capacitive method applied “in process”, as provided for in the present invention, it is possible to determine the quantity of each dosed component simply by making a measurement after each dosing step and calculating it by the difference.

### SUMMARY OF THE INVENTION

As a result, the main purpose of the present invention is to provide a measuring device for a capsule filler machine of pharmaceutical capsules, device which is free of the drawbacks described above and, at the same time, is easy and economical to make.

A further purpose of the present invention is to provide a capsule filler machine, in particular of an intermittent motion type, equipped with at least one aforementioned capacitive measuring device.

According to the present invention, therefore, a measuring device is made for a capsule filler machine according to the contents of claim 1, or any one of the claims directly or indirectly dependent on claim 1.

Furthermore, according to the present invention, a capsule filler machine is provided, in particular of an intermittent motion type, equipped with at least one newly invented measuring device.

### BRIEF DESCRIPTION OF THE DRAWINGS

For a better understanding of the present invention, some preferred embodiments are described below, purely by way of non-limiting examples and with reference to the appended drawings, wherein:

FIG. 1 shows a first embodiment of a measuring device made according to the invention;

FIG. 2 shows some variants of a detail belonging to the measuring device of FIG. 1;

FIG. 3 illustrates an alternative embodiment of some details of the measurement device illustrated in FIG. 1;

FIG. 4 shows the functional diagram of a disc belonging to an intermittent motion capsule filler machine on which a plurality of measurement devices illustrated in FIG. 1 are mounted.

### DETAILED DESCRIPTION OF THE INVENTION

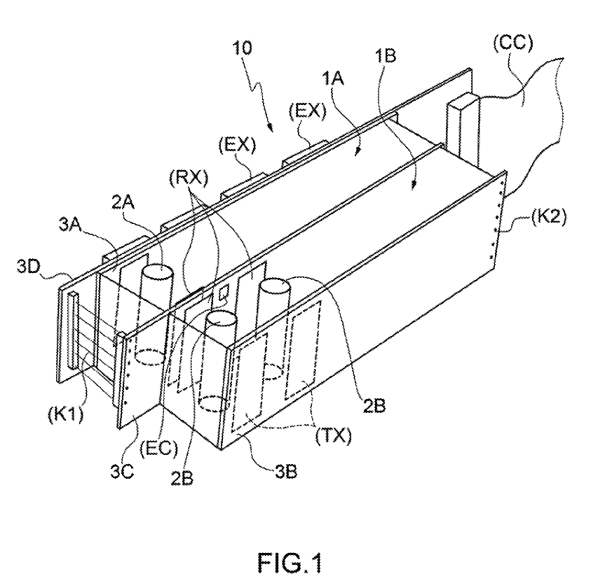

In FIG. 1, reference numeral 10 globally denotes a capacitive measuring device made according to the dictates of the present invention.

The measuring device 10 comprises two identical blocks 1A, 1B, placed one beside the other.

Each block 1A, 1B is shaped like a parallelepiped.

Each block 1A, 1B may be made of an insulating material having suitable dielectric characteristics, typically of a plastic material.

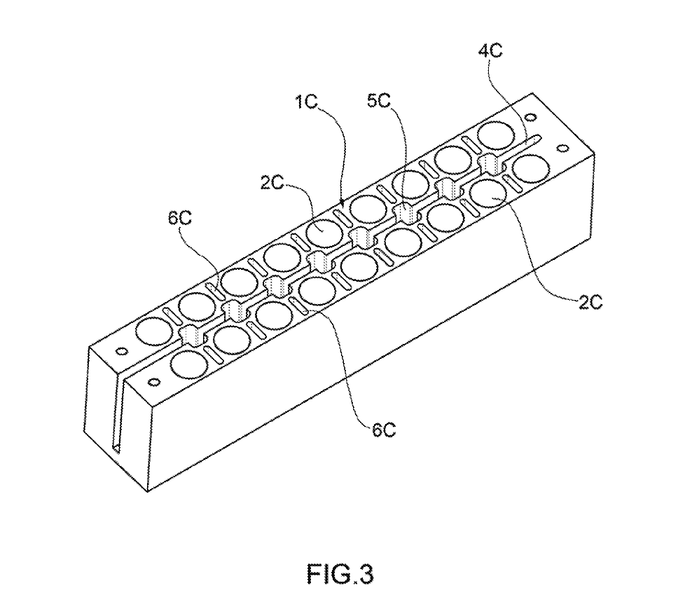

FIG. 3 shows a variant in which the blocks 1A and 1B are made in a single element.

Returning to FIG. 1 it may be seen that each block 1A, 1B is provided with a relative plurality of seats 2A, respectively, 2B; each seat 2A, 2B being suitable to receive a respective bottom (not shown) of a capsule (not shown).

Being a capacitive measuring system, the electrodes connected to a stimulus signal generator will be conventionally indicated as “transmitters” and those connected to the detection and measurement electronics as “receivers”.

On the outer wall of each block 1A, 1B there is a respective printed circuit 3A, 3B, each of them being provided with respective transmitting electrodes (TX), which face towards the inside of said blocks 1A, 1B.

In both these printed circuits 3A, 3B, the presence of active electronics is not normally envisaged, but only copper tracks.

A further printed circuit 3C is positioned between the two blocks 1A, 1B. On both faces of the printed circuit 3C there are receiver electrodes (RX) relative to the seats 2A, 2B.

On the same printed circuit 3C, in the space between one receiver electrode (RX) and another, are the conditioning electronics (EC) of the signals coming from said receiver electrodes (RX).

Using such a solution, the most delicate part of the system (the receiver part) is concentrated in the innermost area of the measuring device 10, and, therefore, in the most “sheltered” region of the whole with respect to external interference.

As shown in FIG. 1, on the outer face of the printed circuit 3A a further 3D printed circuit board is mounted, which contains, mainly in its outer part, all the electronics necessary for the operation of the system (EX), i.e. the generation of the stimulating signals, the analogue-digital conversion part and the micro-controller for signal acquisition and processing and communication management.

The interconnection between the various printed circuits 3A, 3B, 3C, 3D takes place through suitable electronic connection means (K1), (K2); while the connection (power and communication) between the various units and the central control unit (not shown) takes place via a ribbon cable (CC) having, for example, a daisy-chain configuration.

All the elements constituting the measuring device 10 are packed together by fastening means (not shown) preferably, but not necessarily, made of a plastic material.

As will be seen, since the measuring device 10 can be mounted on a disc of an intermittent motion capsule filler machine (see below), preferably such measuring device 10 will have a truncated-pyramidal shape, with a minimum overall dimension outwards, gradually increasing towards the inside of said disc, as indeed appears from FIG. 1.

As seen, the measuring device 10 contains all the transducers necessary to perform a capacitive measurement on all the capsules inserted in the seats 2A, 2B, in a manner substantially similar to that described in the aforementioned document WO-A2-2006/035285.

As already mentioned, in the present case, a single electronics serves not only one transducer, but an entire group of transducers.

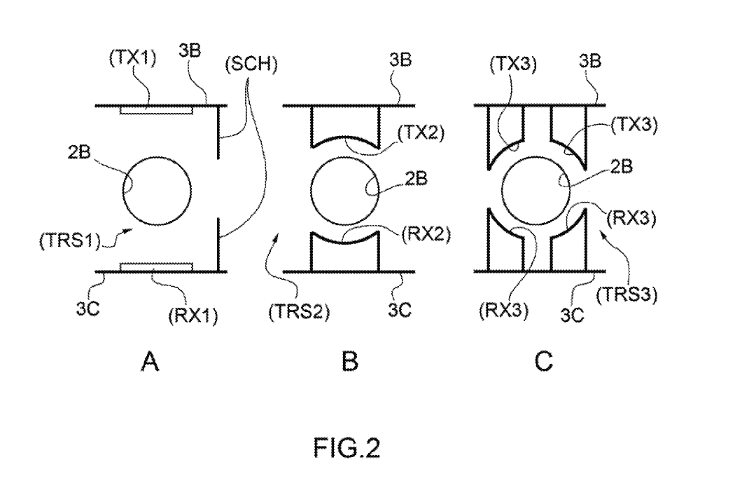

FIGS. 2A, 2B, 2C show three possible alternative embodiments of the transducers used in the measuring device 10.

For the sake of simplicity, all considerations will be made with reference to FIG. 1 on a specimen seat 2B (for a bottom not shown) taken on block 1B. It is obvious that the same observations will also apply to any seat 2A taken in block 1A.

A first type of transducer (TRS1) (shown in FIG. 2A) embraces a seat 2B and comprises a flat rectangular transmitter electrode (TX1), placed on the printed circuit 3B, and a receiver electrode (RX1), also of a flat rectangular shape, belonging to the printed circuit 3C.

In order to reduce the influence between the bottoms placed in adjacent locations 2B, as well as to optimize the performance of the field lines, it is possible to use screening partitions (SCH) made of metal diaphragms welded directly onto the two printed circuits 3B, 3C (FIG. 2A).

Depending on the type of measurement to be carried out and the degree of precision to be achieved in the seat 2B, it is possible to replace the electrodes (TX1), (RX1) with suitably shaped inserts, again fixed to the base printed circuits 3B, 3C, and consisting of an insulating part equipped with suitable electrodes (TX2), (RX2) (second type of transducer (TRS2)), as shown in FIG. 2B.

Similarly, as illustrated in FIG. 2C, it is also possible to have a third type of transducer (TRS3) with four electrodes (TX3), (RX3) (two transmitters and two receivers) for each seat 2B.

Obviously in the latter case, the electronics become more complex since the number of electrodes to be controlled doubles.

As said, in the embodiment of FIG. 3 the two blocks 1A, 1B of the measuring device 10 of FIG. 1 have been replaced by a single block 1C of plastic material.

This block 1C, substantially parallelepiped in shape, comprises a double row of seats 2C. The two rows of seats 2C are parallel to each other.

Between the two rows of seats 2C a longitudinal groove 4C is interposed suitable to receive a printed circuit (not shown) having the functions of the printed circuit 3C of the measuring device 10 of FIG. 1.

The longitudinal groove 4C is interrupted at regular intervals by a plurality of transverse seats 5C, each of which can be used as a space for the arrangement on the printed circuit 3C of the elements belonging to the conditioning electronics (EC) seen in relation to the measuring device 10 of FIG. 1.

Moreover, in block 1C, between one seat 2C and the other there is a respective niche 6C suitable to receive, if necessary, a respective screening partition (not shown) similar to the screening partition (SCH) shown in FIG. 2A.

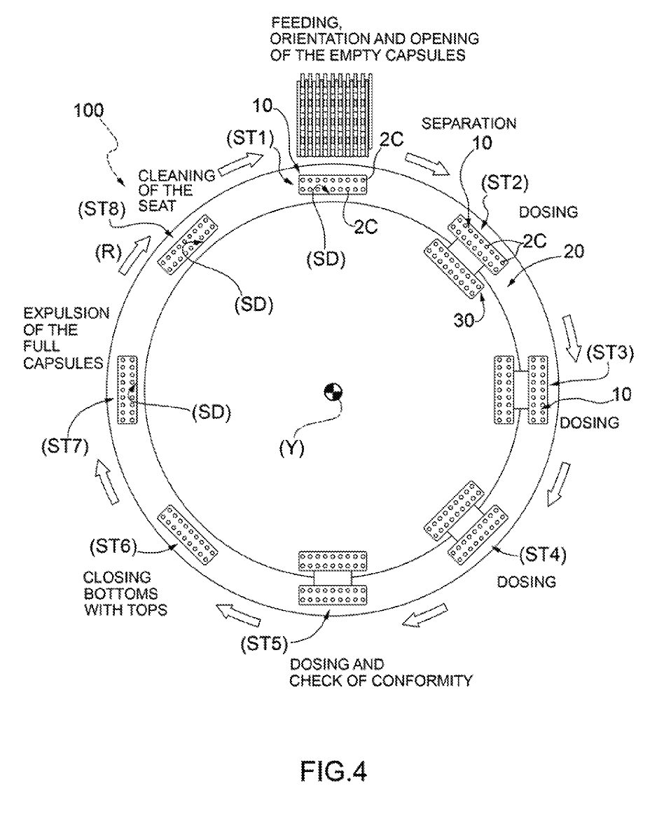

FIG. 4 shows an operating disc 20 which belongs to a capsule filler machine 100 of the intermittent motion type not fully shown.

In the embodiment of FIG. 4, the operating disc 20 rotates clockwise in a direction and vector shown by an arrow (R) around a central vertical axis (Y).

The operating disc 20 rotates in steps of ⅛ of a turn, stopping for the time needed for each station to perform all the operations required to fill the bottoms of the capsules and check the weight of the product contained in each bottom (see below).

On the operative disk 20, rotated by drive means of the known type and not shown around the central vertical axis (Y), a plurality of measuring devices 10 of the type illustrated in FIG. 1 (or, optionally, in the variant shown in FIG. 3) are mounted. In the embodiment of FIG. 4, such measuring devices 10 are eight in number.

The operating disc 20 is associated with 8 fixed stations (ST1), (ST2), (ST3), (ST4), (ST5), (ST6), (ST7), (ST8), placed at steps of ⅛ of turn, each of which is used for a particular function, indicated in FIG. 4 (separation, dosage, etc.).

Furthermore, it is clear that the eight stations (ST1), (ST2), (ST3), (ST4), (ST5), (ST6), (ST7), (ST8) are to be understood as mere conceptual spatial references, which are spatially fixed and, therefore, for example, do not rotate with the operating disc 20, or with any other moving parts of the capsule filler machine 100.

Hypothetically, the operating disc 20 may be made of a metallic material (for example, aluminium) in which eight or more (up to 16) seats are made at intervals, each of which is occupied by a respective measuring device 10.

It is to be noted that currently the seats for the bottoms are made, one by one, by directly drilling the operating disc of the machine.

In the particular embodiment shown in FIG. 4, each measuring device 10 contains two parallel rows of seats 2C for capsule bottoms. Each row comprises N^{o} 9 seats 2C for a total of 18 seats 2C per measuring device 10. Obviously these may also be in a different number and geometrical arrangement.

It is understood that each measuring device 10 is equipped with the above electronics seen in relation to FIG. 1 (and possibly FIG. 3) to check the presence and weight (empty and progressively during the various filling steps) of the bottoms present in the seats 2C of each said measuring device 10.

It should be said incidentally that the tops, corresponding to the bottoms contained in the measuring device 10, are moved by a special transport device 30, which follows, for at least a portion of the journey, the measuring device 10.

The transport device 30, not forming part of the present invention, will not be described in detail.

The number of capsules is generally easy to determine in one or all the stations (ST1), (ST2), (ST3), (ST4), (ST5), (ST6), (ST7), (ST8) of the capsule filler machine 100, since the capacitive sensors as well as mass sensors are obviously also capsule presence sensors.

This fact represents a further advantage of the system, since the event of a capsule coming out of its seat or losing part of the contents, for example due to mechanical stresses, can be immediately identified.

However, as we shall see, the control of the number of capsules takes place preferably, but not necessarily in the station (ST6) where the bottoms are also closed with the relative tops (see below).

The operating disc 20 cyclically moves each measuring device 10 through the aforesaid eight stations (ST1), (ST2), (ST3), (ST4), (ST5), (ST6), (ST7), (ST8) in the following manner:
in a first station (ST1) the feeding of the whole empty capsules and their orientation and opening takes place so as to obtain the bottoms separated from the respective tops; in the first station (ST1) the bottoms are also loaded in the seats 2C and the measuring device 10 measures the mass of the empty bottoms (tare) present in said seats 2C;
the operating disc 20 then makes ⅛ of a turn so as to bring the measuring device 10 into a second station (ST2) where the dosing of a first product in the bottoms contained in the seats 2C of the measuring device 10 itself takes place;
the same operation is repeated in the third station (ST3), in the fourth station (ST4), and in the fifth station (ST5) where the bottoms—if necessary—can be filled respectively with a second, a third, and a fourth product; at the same time the measurement of the individually dosed quantity of product and the check of conformity of said quantity takes place;
in a sixth station (ST6) the closing of each bottom (now filled with the selected products) with a respective top, which, as said, is moved by the aforementioned transport device 30, takes place; in this sixth station (ST6) the check is performed that the capsule is complete with the top; if the top, for any reason, should be absent, as the said measuring device 10 is able to verify, the capsule is discarded by the system in a station (ST7) (see below); moreover, preferably, but not necessarily, the count of the full capsules takes place in the sixth station (ST6);
in the seventh station (ST7) the full capsules are expelled; the resulting compliant capsules go into production, those that are not compliant in the control operations performed after each dosing operation are discarded;
in an eighth and last station (ST8) the seats 2C of the measuring device 10 are cleaned, for example by means of compressed air jets; the same measuring device 10 is able to verify that no whole capsule or fragment of capsule is left inside the respective seat 2A, 2B (or 2C if the solution proposed in FIG. 3 is adopted).

Obviously, all the stations (ST1), (ST2), (ST3), (ST4), (ST5), (ST6), (ST7), (ST8) are simultaneously occupied by different measuring devices 10, so as to make the capsule filler machine 100 work continuously in all the stations.

Each measuring device 10 is functionally independent and is connected to all the other measuring devices and to a central control unit of the machine by means of suitable electrical connections which carry the power supply and a communication line.

Since the measuring devices are all inserted in the rotating functional disc, the connection of these lines (power supply, communication) with the fixed part of the machine takes place with the usual means used in these cases with contact (sliding contact collector) or without (“wireless”, rotary transformer).

On the ground an appropriate management system analyses and uses in the usual way the data sent by the various measuring devices.

As a result, each measuring device is able to perform the measurement in each phase of rotation and in the moments in which this is most appropriate in relation to the movement of the operating disc 20.

Hence the measuring devices are used to detect the presence of empty capsules, to measure the tare of the bottoms, to measure the weight increments due to the individual dosages in the bottoms, to measure the total weights of the closed capsules, to check the presence of the top, to verify after the expulsion of the full capsules that the seats are empty, and, after the cleaning phase, that the seats are effectively clean.

Since the system is very compact, an important part of the realization consists of the measures to minimize the influence between neighbouring capsules, referring both to the simple presence of other capsules next to the one to be measured, and to the influence between the relative electronic circuits.

Such expedients may be:

a) relative to the configuration of the electrostatic system, adopting suitable geometries for the electrodes (including screening) to reduce the influence of adjacent capsules to that being measured;

b) relative to the measurement “strategy” adopted; given the speed of the capacitive system it is possible to carry out measurements not simultaneously but in sequence, on groups of bottoms (or full capsules) suitably selected, or on the individual bottom or individual capsule;

c) relative to the circuits by adopting appropriate configurations to reduce the influence between said circuits; in particular, in the hypothesis (b) of sequential measurement, to ensure that the circuits which are currently not active do not influence the active circuits.

The main advantage of the measuring device described above lies in the fact that its realization is particularly economical when compared with other systems, because with a single electronics, however complex, it is possible to realize a simultaneous measurements and control unit of a significant number of bottoms or capsules.

A further advantage is that the measurement in the various phases (tare, filling) is carried out by the same transducer and in the same seat, thus avoiding the loss of accuracy due to measurements made at different stations by different transducers on capsules inevitably positioned in a different way.

Moreover, the carrying out of a measuring device of such a kind, which as we have seen, constitutes an independent unit of measurement, permits other types of use to be envisaged. For example, it permits the application of one of these units in output to an intermittent motion machine (operation also possible as retrofitting) and therefore—even with the mentioned drawbacks relating to systems without direct measurement of the tare—the realization of a 100% control on production.

1. A measuring device (10) for a capsule filler machine (100) for pharmaceutical capsules, characterized in that it comprises:
at least one block (1A, 1B; 1C), which is provided with a plurality of seats (2A, 2B; 2C), which are suitable to house a plurality of bottoms of capsules to be filled;
said block (1A, 1B; 1C) being provided with capacitive electronic means (3A, 3B, 3C, (TX), (RX), (EC), (EX)), which are suited to detect parameters concerning the tare of each bottom, parameters concerning the quantities and the types of the products inserted into each bottom, and parameters concerning the filling/emptying of said seats (2A, 2B; 2C), so as to control, in particular, the filling steps carried out to fill said capsule bottoms with said products.

2. The measuring device (10), according to claim 1, characterized in that said block (1A, 1B) comprises two identical elements (1A, 1B), which are beside one another; each element (1A, 1B) being provided with a relative plurality of seats (2A, 2B); each seat (2A, 2B) being suitable to receive a respective bottom of a capsule.

3. The measuring device (10), according to claim 1, characterized in that on the outer wall of each element (1A, 1B) there is a respective printed circuit (3A, 3B); each printed circuit (3A, 3B) being provided with respective transmitter electrodes (TX), which face the inside of the elements (1A, 1B).

4. The measuring device (10), according to claim 3, characterized in that a further printed circuit (3C) is placed between said two elements (1A, 1B); receiver electrodes (RX) relating to the seats (2A, 2B) being applied on both faces of said further printed circuit (3C).

5. The measuring device (10), according to claim 4, characterized in that a conditioning electronics (EC) for the signals coming from the receiver electrodes (RX) is located on said printed circuit (3C), between a receiver electrode (RX) and the other.

6. The measuring device (10), according to claim 1, characterized in that it comprises one single element (1C), which is provided with a relative plurality of seats (2C); each seat (2C) being suitable to receive a respective bottom of a capsule.

7. The measuring device (10), according to claim 6, characterized in that said plurality of seats (2C) are arranged along two rows of parallel seats; a longitudinal groove (4C) being interposed between said two rows of seats (2C) and being suitable to receive a printed circuit (3C).

8. The measuring device (10), according to claim 7, characterized in that said longitudinal groove (4C) is interrupted at regular intervals by a plurality of transverse seats (5C), each suitable to house an element belonging to a conditioning electronics (EC).

9. The measuring device (10), according to claim 1, characterized in that it comprises at least one screening partition (SCH).

10. An operating disc (20) for a capsule filler machine (100), characterized in that it comprises at least one measuring device (10) according to claim 1.

11. A capsule filler machine (100), characterized in that it comprises at least one operating disc (20) according to claim 10.

12. The capsule filler machine (100), according to claim 11, characterized in that such a machine is an intermittent motion capsule filler machine.
